(19) United States
(12) Patent Application Publication
(10) Pub. No.: US 2005/0280736 A1
(43) Pub. Date: Dec. 22, 2005

(54) Image capturing apparatus

(75) Inventor: Akihiro Baba, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/061,286

(22) Filed: Feb. 17, 2005

(30) Foreign Application Priority Data
Jun. 22, 2004 (JP) 2004-183514

(51) Int. Cl. H04N 5/222

(52) U.S. Cl. 348/371

(57) ABSTRACT

A digital camera 1A is an image capturing apparatus that performs image capturing and generates image data according to the captured image. In the digital camera 1A, a built-in electronic flash device 25 protrudes to a front side of the camera body 21. A main capacitor 45 used for the flash light emission of the flash 25 is disposed in an internal space SP of the camera body 21 behind the flash 25 which space SP is formed by the protrusion.

This application is based on application No. 2004-183514 filed in Japan, the content of which is hereby incorporated by reference.

### BACKGROUND OF THE INVENTION

1. Field of the Invention

The present invention relates to an image capturing apparatus having a built-in electronic flash device.

2. Description of the Related Art

Cameras provided with a telephoto lens having a long focal length are sometimes required to incorporate an electronic flash device of a large light emission amount so that the flash light reaches far away. To realize such an electronic flash device of a large light emission amount, it is necessary to increase the capacitance of a main capacitor that accumulates the electric charges for causing the electronic flash device to emit light. On the other hand, cameras are required to decrease in size, and to secure a space for placing a large-capacitance main capacitor in the camera body, it is necessary to appropriately arrange members constituting the camera in the camera body.

For example, in single-lens reflex cameras using film, having an electronic flash device in a position closer to the front than to the rear above the taking lens and having a viewfinder in a position closer to the rear than to the front above the taking lens, a pentagonal roof prism occupying a large volume is provided in a space formed between the electronic flash device and the viewfinder in the camera body. The above-mentioned main capacitor is disposed in the grip portion or the film winding spool. There are cases where a plurality of capacitors is disposed so as to be distributed in the shoulder portion of the camera body.

Moreover, examples of other kinds of cameras using film and called compact cameras and the like include one in which the main capacitor is disposed in front of the viewfinder for size reduction and one in which the main capacitor is disposed behind the viewfinder for size reduction.

On the other hand, in digital cameras, in particular digital cameras provided with a high-magnification zoom lens, there are cases where an arrangement such that the centers of members such as the electronic viewfinder, the electronic flash device and the rear display portion are included in a vertical plane including the optical axis of the taking optical system is adopted to realize a design suitable for a camera. Moreover, in digital cameras, a plurality of high-versatility batteries such as size AA batteries is frequently used as the power source and it is necessary to secure a space for placing the batteries in the camera body. For these reasons, in image capturing apparatuses such as digital cameras, the disposition of the main capacitor similar to that of the above-described cameras using film makes it impossible to effectively use the space inside the camera body, so that size reduction cannot be realized.

### SUMMARY OF THE INVENTION

The present invention is made to solve the above-mentioned problem, and an object thereof is to provide an image capturing apparatus capable of realizing size reduction.

To attain the above-mentioned object, a first aspect of the invention provides an image capturing apparatus comprising: a taking lens that images incident light from a front of the image capturing apparatus, the taking lens being disposed on a front side of a housing of the image capturing apparatus; a built-in electronic flash device that emits flash light forward of the image capturing apparatus, the built-in electronic flash device being disposed above an optical axis of the taking lens; and a capacitor that accumulates electric charges used for flash light emission of the built-in electronic flash device, wherein the capacitor is disposed in an internal space of the housing behind the built-in electronic flash device, the internal space being formed by forming the built-in electronic flash device so as to protrude forward on the front surface of the housing.

According to the above-described structure, since the internal space of the housing behind the built-in electronic flash device which space is formed by forming the built-in electronic flash device so as to protrude forward on the front surface of the housing can be effectively used, the image capturing apparatus can be reduced in size.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a front view of a digital camera 1A.

FIG. 2 is a rear view of the digital camera 1A.

FIG. 3 is a top view of the digital camera 1A.

FIG. 4 is a bottom view of the digital camera 1A.

FIG. 5 is a left side view of the digital camera 1A.

FIG. 6 is a right side view of the digital camera 1A.

FIG. 7 is a view of the internal structure of the digital camera 1A viewed from above.

FIG. 8 is a view of the internal structure of the digital camera 1A viewed from the front.

FIG. 9 is a view of the internal structure of the digital camera 1A viewed from below.

FIG. 10 is a cross-sectional view of the digital camera 1A taken on the line X-X of FIG. 1.

FIG. 11 is a block diagram showing a functional structure of the digital camera 1A;

FIG. 12 is a cross-sectional view of a digital camera 1B.

FIG. 13 is a cross-sectional view of a digital camera 1C.

FIG. 14 is a cross-sectional view of a digital camera 1D.

FIG. 15 is a cross-sectional view of a digital camera 1E.

### DETAILED DESCRIPTION OF THE PREFERRED EMBODIMENTS

### First Embodiment

A digital camera 1A of a first embodiment is an image capturing apparatus that performs image capturing and generates image data according to the captured image. In the digital camera 1A, a built-in electronic flash device (hereinafter, sometimes referred to merely as “flash”) 25 is disposed so as to protrude forward to the front side of the camera body 21. In the digital camera 1A, a main capacitor 45 that accumulates the electric charges used for the flash light emission of the flash 25 is disposed in an internal space SP of the camera body 21 behind the flash 25 which space SP is formed by the protrusion. From a different viewpoint, in the digital camera 1A, the main capacitor 45 is disposed in the internal space SP of the camera body 21 formed between the flash 25 and the electronic viewfinder (hereinafter, also referred to merely as EVF) 23.

<External Structure>

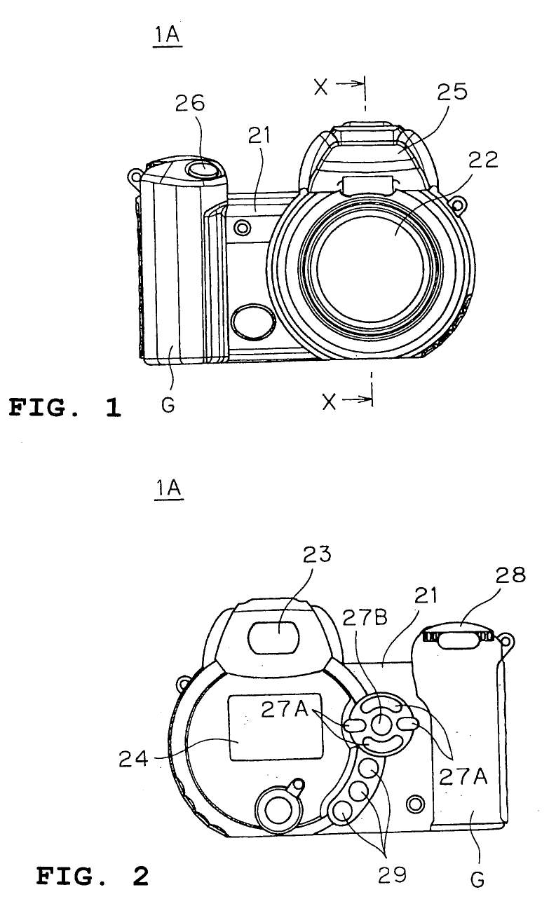

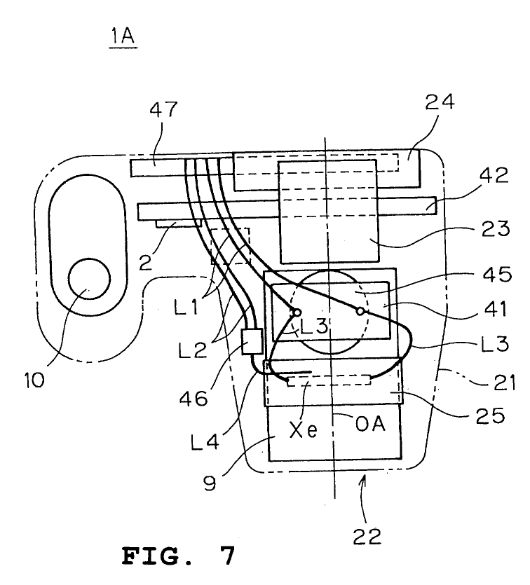

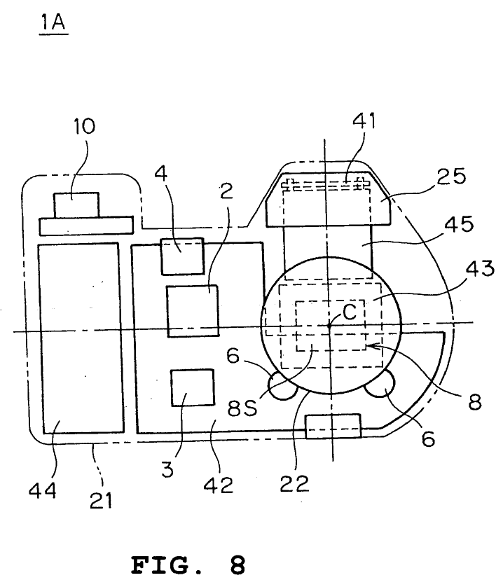

With reference to FIGS. 1 to 6, the external structure of the digital camera 1A will be described.

As shown in FIG. 1, a taking lens 22 is provided on the front side of the camera body 21 which is the housing of the digital camera 1A. The taking lens 22 images the incident light from the front of the digital camera 1A, on the light receiving surface 8S of a CCD (charge coupled device) 8 (see FIGS. 8 to 10). The taking lens 22 is, for example, a zoom lens with a zoom magnification of 8× (focal length 6 to 48 mm).

The flash 25 of a pop-up type that emits flash light forward of the digital camera 1A is also provided on the front side of the camera body 21. The flash 25 is disposed vertically above the optical axis OA of the taking lens 22 (see FIGS. 7 to 10). In order to prevent the taking lens 22 from hindering the flash light from reaching the subject (so-called vignetting), the flash 25 is disposed in a position protruding to the front of the camera body 21 to an extent that does not spoil the design of the digital camera 1A. The flash 25 in the housed condition shown in FIGS. 1 to 6 can pop up by a predetermined operation by the user. The flash 25 in the pop-up condition can be used for flash photographing. Preferably, the flash 25 is provided so as to protrude approximately 5 to 30 mm forward on the front surface of the camera body 21.

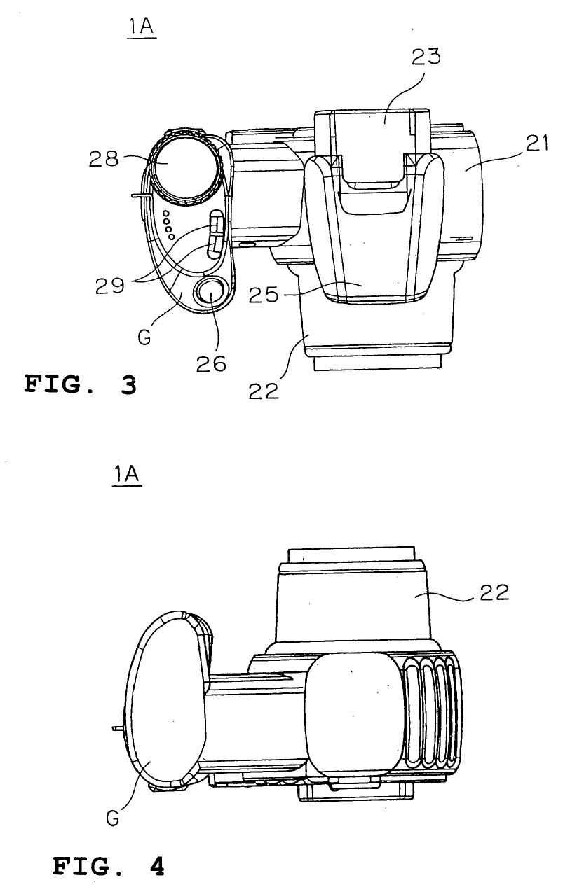

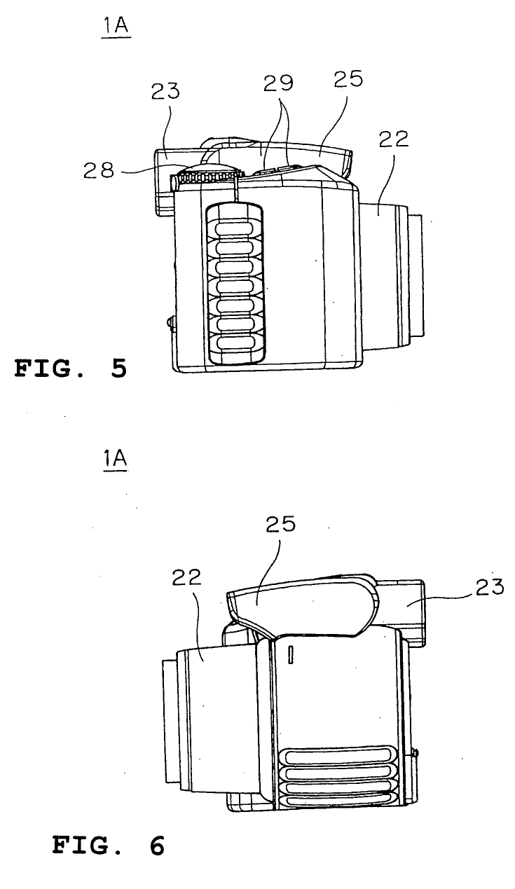

A grip G for facilitating the hold of the digital camera 1A is formed on the left side of the camera body 21 as viewed from the front of the camera 1A (FIG. 1). As shown in FIG. 3, a shutter start button (hereinafter, referred to merely as shutter button) 26 is provided in a position closer to the front side on the top surface of the grip G. The shutter button 26 is a two-stroke push button switch a half depressed condition and a fully depressed condition of which can be detected. The half depression of the shutter button 26 serves as the trigger to cause the digital camera 1A to perform the exposure preparation operation such as automatic focusing control, the full depression of the shutter button 26 serves as the trigger to cause the digital camera 1A to perform the regular exposure operation for recording an image.

A mode setting dial 28 is provided in a position closer to the rear side on the top surface of the grip G. The mode setting dial 28 is used for setting the exposure mode of the digital camera 1A. Various setting buttons 29 used for setting the macro mode and the flash mode are provided between the shutter button 26 and the mode setting dial 28.

As shown in FIG. 2, the EVF 23 and a rear monitor 24 are provided on the rear surface of the camera body 21. The EVF 23 is disposed vertically above the optical axis OA of the taking lens 22. The EVF 23 is provided so as to protrude approximately 5 to 10 mm to the rear side from the rear surface of the camera 1A, preferably, in order that the user can perform the viewing through the viewfinder from behind the camera body 21.

With this structure, the image displayed on the EVF 23 can be viewed from behind the camera body 21. A live view image (real time moving image formed by the taking lens 22) in the image capturing standby state, a reproduced image that is read out from a memory card 13 (see FIG. 11) and a menu screen are displayed on the EVF 23 or the rear monitor 24. The flash 25, the EVF 23 and the rear monitor 24 are disposed so that the centers thereof are included in a vertical plane including the optical axis OA of the taking lens 22. By adopting the EVF 23 as the viewfinder, a large-size pentagonal roof prism is unnecessary, so that the internal space SP for disposing the main capacitor 45 can be easily secured.

A four-way key 27A comprising four buttons in the vertical and horizontal directions is provided on the right side of the rear monitor 24. An enter button 27B is provided in the middle of the four buttons of the four-way key 27A. The four-way key 27A is used for moving the cursor on the menu screen and advancing the frame of the reproduced image. The enter button 27B is used for accepting the selection from a menu of choices by the cursor.

Further, the setting buttons 29 used for the invocation of the menu screen on the rear monitor 24, the reproduction display of the latest recorded image on the rear monitor 24 (quick view) and the erasure of the reproduced “quick view” image, the selection between the EVF 23 and the rear monitor 24, and the like are provided on the rear surface of the camera body 21.

<Internal Structure>

With reference to FIGS. 7 to 9, the internal structure of the digital camera 1A will be described.

As shown in FIG. 7, in the digital camera 1A, the main capacitor 45 and a flash circuit board 41 are provided between the flash 25 and the EVF 23. Details of the main capacitor 45 and the flash circuit board 41 will be described in the section of <Main capacitor and flash circuit board>.

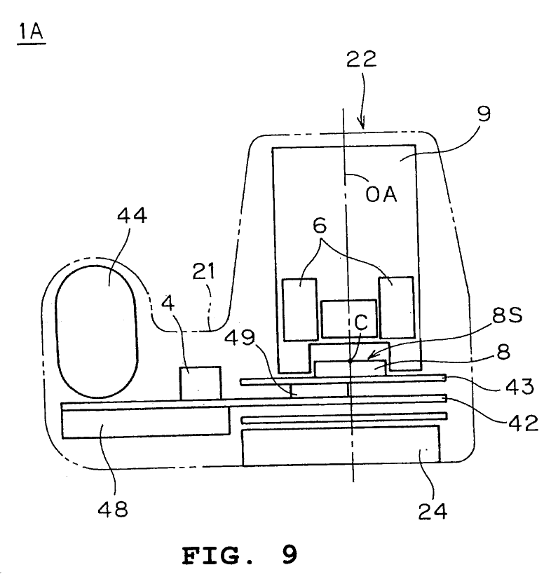

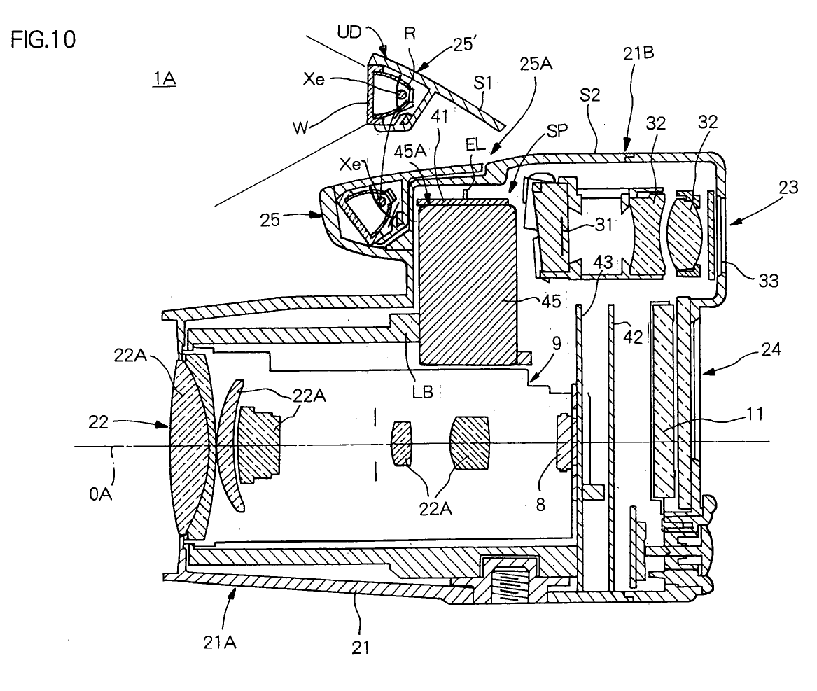

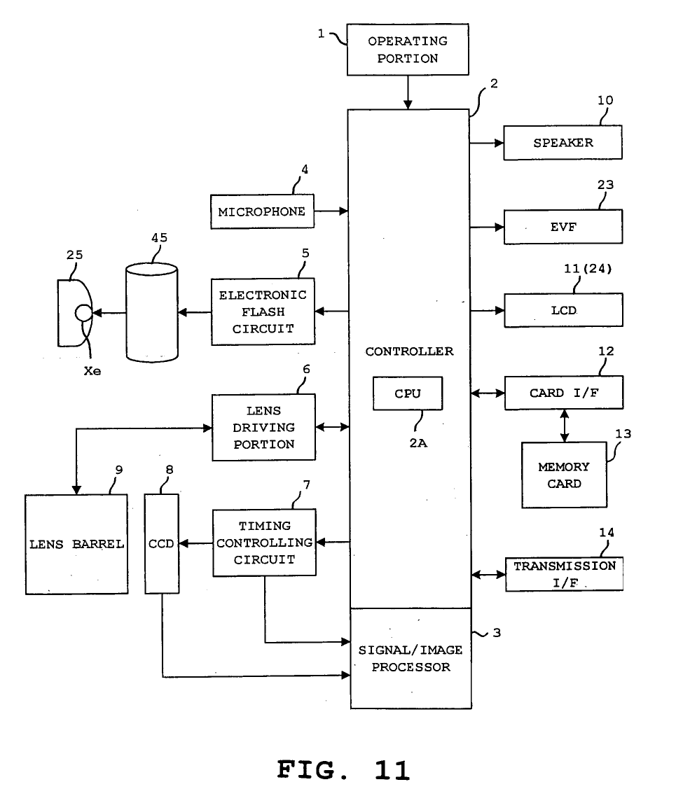

The taking lens 22 comprises a substantially cylindrical lens barrel 9 to which a plurality of lens units 22A is interlocked directly or indirectly (see FIG. 10). As shown in FIGS. 7 and 9, the lens barrel 9 is disposed so that the optical axis OA of the taking lens 22 is vertical to the front and rear surfaces of the camera body 21. Moreover, a lens driver 6 that drives the lens units 22A is attached to the lens barrel 9.

The CCD 8 is disposed behind the lens barrel 9. The CCD 8 is attached to a CCD board 43. Various electronic parts as well as the CCD 8 are provided on the CCD board 43. The CCD board 43 is disposed so that the optical axis OA of the taking lens 22 vertically intersects the light receiving surface 8S of the CCD 8 at the center C.

A main board 42 is disposed behind the CCD board 43. As shown in FIG. 8, various electronic parts such as a controller (e.g. one-chip microcomputer) 2, a signal and image processor (e.g. one-chip digital signal processor) 3 and a microphone 4 are provided on the main board 42. Moreover, a card holder 48 to which the memory card 13 into which image data is to be recorded is detachably attachable is also attached to the main board 42. The main board 42 and the CCD board 43 are connected together by a connector 49. The connector 49 enables the main board 42 to output various control signals to the CCD board 43 and obtain the image signal according to the image taken by the CCD 8 from the CCD board 43.

The rear monitor 24 is realized by making the display contents of a liquid crystal display 11 (see FIG. 10) provided in the vicinity of the rear surface inside the camera body 21 visible through a rectangular hole formed in the rear surface of the camera body 21.

A power source board 47 where a boosting circuit for the flash is provided is also provided in the vicinity of the rear surface inside the camera body 21. The power source board 47 electrically connected to the main capacitor 45 by a lead wire L1 charges the main capacitor 45. The main capacitor 45 and a flash light emission tube (xenon tube) Xe are electrically connected together by a lead wire L3. The lead wire L3 enables the electric power for light emission to be supplied from the main capacitor 45 to the flash light emission tube Xe. Further, the power source board 47 is electrically connected also to a trigger coil 46 by a lead wire L2.

The trigger coil 46 and the flash light emission tube Xe are connected together by a lead wire L4 for supplying a trigger to the flash light emission tube Xe. The lead wires L2 and L4 enable the power source board 47 to supply a trigger for light emission to the flash light emission tube Xe included in the flash 25.

In the grip G, a speaker 10 is provided, and a battery 44 that supplies the operating power of the digital camera 1A is housed.

<Main Capacitor and Flash Circuit Board>

With reference to FIG. 10, the internal structure of the digital camera 1A including the main capacitor and the flash circuit board will be described.

As mentioned above, in the digital camera 1A, the flash 25 protrudes forward to the front side of the camera body 21, and the main capacitor 45 is disposed in the internal space SP of the camera body 21 behind the flash 25 which space SP is formed by the protrusion. Further, the EVF 23 is disposed behind the main capacitor 45.

From a different viewpoint, as mentioned in the section of <External structure>, in the digital camera 1A, the flash 25 is disposed in a position closer to the front side, and the EVF 23 is disposed in a position closer to the rear side. For this reason, the internal space SP of the camera body 21 formed between the flash 25 and the EVF 23 is suitable for disposing a large-size member. Therefore, in the digital camera 1A, the main capacitor 45 is disposed in the internal space SP.

With this arrangement, the large-capacitance main capacitor 45 can be provided in the digital camera 1A and the light emission amount of the flash 25 can be increased. Moreover, by effectively using the internal space SP above the lens barrel 9, the digital camera 1A can be reduced in size.

Further, the main capacitor 45 is disposed on a lens barrel LB of the taking lens 22 so as to partially enter into the lens barrel LB from above. The main capacitor 45 is situated above the neighborhood of the rear part of the taking lens 22. That is, since the neighborhood of the rear part of the taking lens 22 is a position where the luminous flux formed by the taking lens 22 comparatively converges, it is all the more easy to cause the main capacitor 45 to enter the lens barrel as described above. This enables the use of a larger-capacitance main capacitor 45.

Next, the main capacitor 45 and the flash circuit board 41 will be described. The main capacitor 45 is, typically, an aluminum electrolytic capacitor with a capacitance of 240 μF and a withstand voltage of 350 V having a cylindrical shape that is 18 mm in diameter and 25 mm in height. In the digital camera 1A, the main capacitor 45 that is cylindrical is disposed vertically above the lens barrel 9. That is, the cylindrical axis direction of the main capacitor 45 is the vertical direction of the digital camera 1A. The main capacitor 45 is a radial leaded component where two electrode lead wires EL protrude from one end surface 45A. It is to be noted that the main capacitor 45 may be an axial leaded component or a surface-mount chip component. The above-mentioned size, shape and electric characteristics of the main capacitor 45 are merely an example, and does not limit the invention.

The flash circuit board 41 that controls the light emission of the flash 25 has a rectangular shape. On the flash circuit board 41, the main capacitor 45 is directly provided and various electronic parts of a flash circuit 5 are provided. In the digital camera 1A, the flash circuit board 41 is disposed above the main capacitor 45.

The EVF 23 is provided in a position inside the camera body 21 and above the rear monitor 24, the main board 42 and the CCD board 43. The EVF 23 has a small-size liquid crystal display 31 and a finder lens 32, and an image of the image displayed on the liquid crystal display 31 can be viewed through the finder lens 32 and a finder window 33.

The flash has a part UD that goes up and down with respect to a non-illustrated axis, and has the flash light emission tube Xe, a reflector R, a light emitting window W and the like in the vicinity of the front end of the part. Moreover, the top surface S1 of the up-down part UD constitutes an external part of the camera. When the up-down part UD pops up, it goes up to a position 25′ of FIG. 10 so that the light emitting window W faces the front, and when the up-down part UD is pushed down, the light emitting window W is housed so as to face slightly downward in the position 25 of FIG. 10, that is, a position in front of the main capacitor 45. At this time, the flash 25, the main capacitor 45 and the EVF 23 are substantially in a line from the front as shown in FIG. 10. Moreover, by this, the top surface (external part) S1 of the up-down part UD is substantially smoothly continuous with the external part top surface S2 of the part where the EVF 23 is housed.

The lead wire L3 electrically connected to the flash light emission tube Xe of the flash 25 is directed into the camera body 21 through a hole formed at the center of the pivot 25A of the flash 25, and is connected to the main capacitor 45.

<Functional Structure>

With reference to FIG. 11, a functional structure of the digital camera 1A will be described.

The digital camera 1A is provided with the controller 2. The controller 2 is a microcomputer including a CPU 2A, and performs the centralized control of the elements of the digital camera 1A according to a predetermined program. The controller 2 detects the condition of an operation portion 1 including the shutter button 26, the four-way key 27A, the enter button 27B, the mode setting dial 28 and the setting buttons 29, and causes the digital camera 1A to operate based on the result of the detection.

The controller 2 outputs image data according to the image to the EVF 23 or the liquid crystal display (LCD) 11 (rear monitor 24), and causes the EVF 23 or the liquid crystal display 11 to display the image so as to be viewable. Moreover, the controller 2 is capable of accessing the memory card 13 through a card interface (card I/F) 12. This enables the controller 12 to read out the image data recorded in the memory card 13 and record image data into the memory card 13.

The CCD 8 as the image sensor photoelectrically converts the subject image formed on the light receiving surface 8S by the taking lens 22, to an image signal, and outputs the image signal to the signal and image processor 3. The signal and image processor 3 performs predetermined processing on the image signal to generate image data in synchronism with a driving control signal supplied from a timing control circuit 7. The generated image data is recorded into the memory card 13 through the controller 2, and used for the display of the live view image on the EVF 23 or the liquid crystal display 11 in the capturing standby state.

The timing control circuit 7 generates a driving control signal of the CCD 8 based on a reference clock signal supplied from the controller 2. The generated driving control signal is outputted to the CCD 8 and the signal and image processor 3.

The lens driver 6 drives the lens units 22A constituting the taking lens 9 based on a control signal supplied from the controller 2. This enables the digital camera 1A to change the focal length (zoom magnification) and focus condition of the taking lens 22. More specifically, the digital camera 1A adopts an automatic focus control that realizes in-focus state by calculating an in-focus evaluation value from the image data according to the image taken by the CCD 8 and driving the lens units 22A so that the in-focus evaluation value is highest.

Moreover, in the digital camera 1A, the light emission amount control in the flash photographing is performed by the controller 2 and the flash circuit 5. The flash circuit 5 supplies the electric power for flash light emission to the main capacitor 45 based on a control signal supplied from the controller 2. The electric power is discharged by the flash light emission tube Xe of the flash 25 at the time of flash light emission.

Further, the speaker 10 used for the reproduction of sound and the generation of a notification sound and the microphone 4 used for the recording of sound are connected to the controller 2. Moreover, a communication interface (communication I/F) 14 for communication with external apparatuses is also connected to the controller 2.

### Second Embodiment

While the digital camera 1A adopting the pop-up flash 25 is shown in the first embodiment, in a second embodiment, a digital camera 1B adopting a fixed flash 125 is shown. Except for the flash 125, the digital camera 1B has a similar structure to that of the digital camera 1A. For this reason, of the elements of the digital camera 1B, similar elements to those of the digital camera 1A are denoted by the same reference numerals and detailed descriptions thereof are omitted.

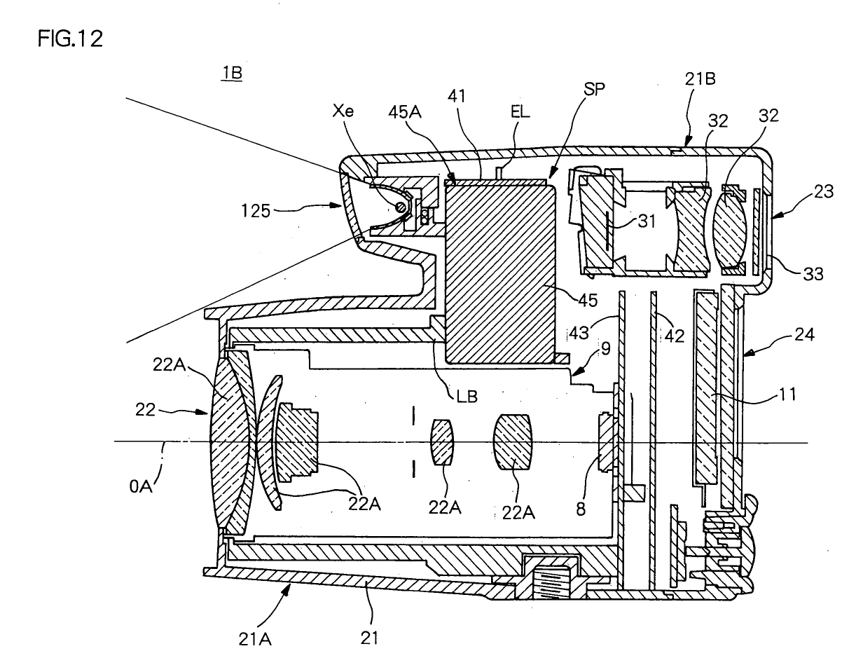

As shown in the cross-sectional view of FIG. 12 corresponding to FIG. 10 of the first embodiment, the digital camera 1B corresponds to one where the flash 25 of the digital camera 1A is replaced with the fixed flash 125. In the digital camera 1B, the large-capacitance main capacitor 45 can also be provided and the light emission amount of the flash 125 can also be increased. Moreover, by effectively using the internal space SP above the lens barrel 9, the digital camera 1B can be reduced in size.

### Third Embodiment

While the digital camera 1A in which the main capacitor 45 is vertically placed above the lens barrel 9 is shown in the first embodiment, in a third embodiment, a digital camera 1C in which the main capacitor 45 is horizontally placed above the lens barrel 9 is shown. Except for the disposition of the main capacitor 45 and a flash circuit board 24, the digital camera 1C has a similar structure to that of the digital camera 1A. For this reason, of the elements of the digital camera 1C, similar elements to those of the digital camera 1A are denoted by the same reference numerals and detailed descriptions thereof are omitted.

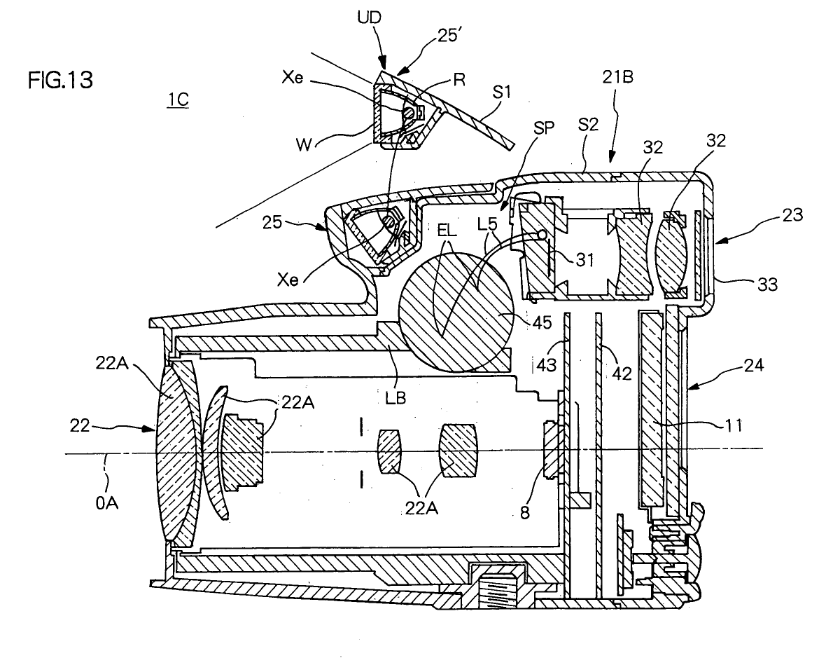

As shown in the cross-sectional view of FIG. 13 corresponding to FIG. 10 of the first embodiment, the digital camera 1C corresponds to one where the direction of disposition of the main capacitor 45 of the digital camera 1A is changed from the vertical direction to the horizontal direction. That is, in the digital camera 1C, the cylindrical axis direction of the main capacitor 45 is the horizontal direction of the digital camera 1C. Further, in the digital camera 1C, the flash circuit board is provided on a side (not shown) of the EVF 23. The electrode EL of the main capacitor 45 and the flash circuit board 24 are connected together by a lead wire L5. In the digital camera 1C, the large-capacitance main capacitor 45 can also be provided and the light emission amount of the flash 25 can also be increased. Moreover, by effectively using the internal space SP above the lens barrel 9, the digital camera 1C can be reduced in size.

In the digital camera 1C, a fixed flash may be used instead of the pop-up flash 25.

### Fourth Embodiment

While the digital camera 1B in which the different display devices 11 and 31 are provided for the rear monitor 24 and the EVF 23, respectively, is shown in the second embodiment, in a fourth embodiment, a digital camera 1D using a single display device (liquid crystal display 11) as the display device of both the rear monitor 24 and the EVF 23 is shown.

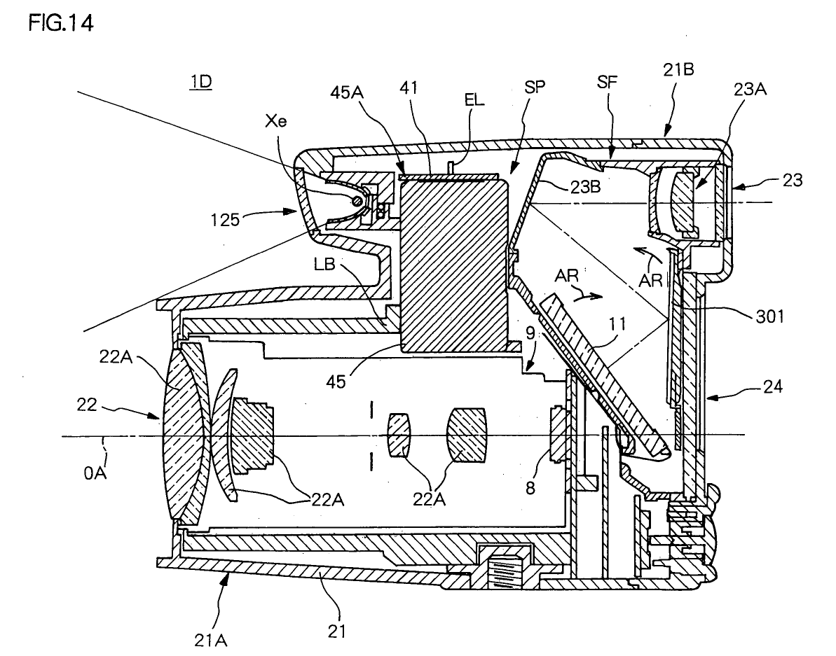

The switching between the rear monitor 24 and the EVF 23 in the digital camera 1D is realized by switching the position of the liquid crystal display 11 and a movable mirror 301 incorporated in the camera body 21. The finder having this switching mechanism will hereinafter be sometimes referred to as “switch finder.” FIG. 14 corresponding to FIG. 10 of the first embodiment is a cross-sectional view showing the digital camera 1D provided with a switch finder SF. The switch finder SF has an eyepiece optical system 23A, a fixed mirror 23B, the movable mirror 301 and the liquid crystal display 11.

FIG. 14 shows the disposition of the movable mirror 301 and the liquid crystal display 11 when the EVF 23 is used. The switching from the EVF 23 to the rear monitor 24 is realized by swinging the movable mirror 301 and the liquid crystal display 11 in the direction of the arrow AR. Since the digital camera 1D has a similar structure to that of the digital camera 1B except for the switching finder SF, of the elements of the digital camera 1D, similar elements to those of the digital camera 1B are denoted by the same reference numerals and detailed descriptions thereof are omitted.

In the digital camera 1D, the large-capacitance main capacitor 45 can also be provided and the light emission amount of the flash 25 can also be increased. Moreover, by effectively using the internal space SP above the lens barrel 9, the digital camera 1D can be reduced in size.

### Fifth Embodiment

While the digital cameras 1A to 1D adopting the EVF are shown in the first to fourth embodiments, the adoption of an optical viewfinder having a pentagonal roof prism is not excluded. Therefore, in a fifth embodiment, a digital camera 1E adopting an optical viewfinder is shown. Except for optical systems such as the taking lens and the optical viewfinder, the digital camera 1E has a similar structure to that of the digital camera 1A. For this reason, of the elements of the digital camera 1E, similar elements to those of the digital camera 1A are denoted by the same reference numerals and detailed descriptions thereof are omitted.

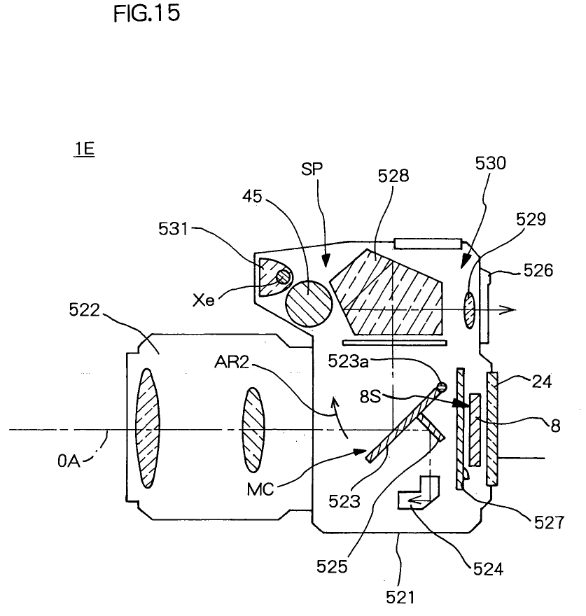

With reference to FIG. 15, the digital camera 1E of the single-lens reflex type will be described.

An interchangeable taking lens 522 is attached to a lens mount provided on the front surface of the camera body 521 of the digital camera 1E. At the time of exosure, the taking lens 522 images the incident light from the front of the digital camera 1E, on the light receiving surface 8S of the CCD 8. Since the taking lens 522 is detachably attachable to the camera body 521, the user can use a desired taking lens for photographing by attaching it to the camera body 521.

A main mirror 523 is provided in the camera body 521. The main mirror 523 is pivotable about the pivot 523a. The central part MC in the vicinity of the intersection of the optical axis OA of the taking lens 522 and the main mirror 523 is a semitransparent mirror.

During exposure standby when the main mirror 523 is in the position shown in FIG. 15, the incident light through the taking lens 522 is split into transmitted light that reaches a focus condition detection module 524 and reflected light that reaches an eyepiece window 526. At the time of exposure when the main mirror 523 is pivoted up approximately 45° from the position shown in FIG. 15 in the direction of the arrow AR2, the incident light through the taking lens 522 passes through the aperture of a focal plane shutter 527 and is imaged on the light receiving surface 8S of the CCD 8.

During the exposure standby state, the light transmitted by the main mirror 523 is reflected by a sub mirror 525 which is a total reflection mirror attached to the main mirror 523, and is then directed to the focus condition detection module 524 of the phase difference detection type. The focus condition detection module 524 is provided for detecting the focus condition of the taking lens 522. The digital camera 1E performs automatic focusing control based on the detection result of the focus condition detection module 524.

The light reflected by the main mirror 523 is converted to a normal image by a pentagonal roof prism 528, and is directed to the eyepiece window 526 by way of an eyepiece lens 529. By an optical viewfinder 530 including the eyepiece window 526, the eyepiece lens 529 and the pentagonal roof prism 528, the image according to the image formed by the taking lens 522 can be viewed from behind the digital camera 1E.

The fixed flash 531 is also disposed on the front surface of the camera body 521. The flash 531 is disposed vertically above the optical axis OA of the taking lens 522. In order to prevent the taking lens 522 from hindering the flash light from reaching the subject, the flash 531 is disposed in a position protruding to the front side of the camera body 521 to an extent that does not spoil the design of the digital camera 1E. Preferably, the flash 531 is provided so as to protrude approximately 5 to 30 mm on the front surface of the camera body 521. The main capacitor 45 that accumulates the electric charges used for the flash light emission of the flash 531 is disposed in the internal space SP of the camera body 521 behind the flash 531 which space SP is formed by the protrusion. Further, the optical viewfinder 530 is disposed behind the main capacitor 45.

From a different viewpoint, in the digital camera 1E, the flash 531 is disposed in a position closer to the front than to the rear, and the optical viewfinder 530 is disposed in a position closer to the rear than to the front. For this reason, the internal space SP of the camera body 521 formed between the flash 531 and the optical viewfinder 530 is suitable for disposing a large-size part. Therefore, in the digital camera 1E, the main capacitor 45 that accumulates the electric power used for the light emission of the flash 531 is disposed in the internal space SP.

With this arrangement, the large-capacitance main capacitor 45 can be provided in the digital camera 1E and the light emission amount of the flash 531 can be increased. Moreover, by effectively using the internal space SP, the digital camera 1E can be reduced in size.

<Modification>

While the EVF and the flash are both disposed vertically above the optical axis of the taking lens in the above-described embodiments, it is to be noted that it is unnecessary that they be disposed strictly vertically above the optical axis and it is necessary only that they be disposed vertically above the optical path of the taking lens (the position of passage of the luminous flux formed by the taking lens).

The above-described structure is an image capturing apparatus in which the following are provided: a taking lens that images incident light from the front of the image capturing apparatus and is disposed on the front surface of the housing of the image capturing apparatus; a built-in electronic flash device that emits flash light forward of the image capturing apparatus and is disposed above the optical axis of the taking lens; and a capacitor that accumulates the electric charges used for the flash light emission of the built-in electronic flash device, and the capacitor is disposed in an internal space of the housing behind the built-in electronic flash device which space is formed by forming the built-in electronic flash device so as to protrude forward on the front surface of the housing.

Moreover, in the above-described image capturing apparatus, a viewfinder that displays an image according to an image formed by the taking lens so as to be viewable from behind the housing is further provided, and the viewfinder is disposed behind the capacitor.

According to these structures, since the internal space of the housing behind the built-in electronic flash device which space is formed by forming the built-in electronic flash device so as to protrude forward on the front surface of the housing can be effectively used, the image capturing apparatus can be reduced in size.

Moreover, the above-described structure is an image capturing apparatus in which the following are provided: a taking lens that images incident light from the front of the image capturing apparatus and is disposed on the front surface of the housing of the image capturing apparatus; a built-in electronic flash device that emits flash light forward of the image capturing apparatus and is disposed in a position closer to the front side above the optical axis of the taking lens; a viewfinder that displays an image according to an image formed by the taking lens so as to be viewable from behind the housing and is disposed in a position closer to the rear side above the optical axis of the taking lens; and a capacitor that accumulates the electric charges used for the flash light emission of the built-in electronic flash device, and the capacitor is disposed in an internal space of the housing formed between the built-in electronic flash device and the viewfinder.

According to this structure, since the internal space of the housing formed between the built-in electronic flash device and the viewfinder can be effectively used, the image capturing apparatus can be reduced in size.

Moreover, in the above-described image capturing apparatus, the viewfinder is an electronic viewfinder that displays an image according to electronic image data.

According to this structure, since a large-size pentagonal roof prism is unnecessary by the adoption of the electronic viewfinder, the space for disposing the capacitor can be further easily secured.

Moreover, in the above-described image capturing apparatus, the capacitor is disposed on the lens barrel constituting the taking lens.

According to this structure, since the capacitor is disposed above the lens barrel, the internal space above the lens barrel can be effectively used.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. An image capturing apparatus comprising:
a built-in electronic flash device that emits flash light forward of the image capturing apparatus, the built-in electronic flash device being disposed above an optical axis of a taking lens which positions on a front side of a housing of the image capturing apparatus for imaging incident light from a front of the image capturing apparatus; and
a capacitor that accumulates electric charges used for flash light emission of the built-in electronic flash device,
wherein the capacitor is disposed in an internal space of the housing behind the built-in electronic flash device, the internal space being formed by forming the built-in electronic flash device so as to protrude forward from a front side of the housing.

2. An image capturing apparatus according to claim 1 further comprising a viewfinder that displays an image according to an image formed by the taking lens so as to be viewable from behind the housing, and wherein the viewfinder is disposed behind the capacitor.

3. An image capturing apparatus according to claim 2, wherein the viewfinder is an electronic viewfinder that displays an image according to electronic image data.

4. An image capturing apparatus according to claim 1, wherein the capacitor is disposed above a lens barrel constituting the taking lens.

5. An image capturing apparatus according to claim 4, wherein the capacitor is so arranged that the capacitor partially enters into the lens barrel from above.

6. An image capturing apparatus according to claim 1, wherein the taking lens is interchangeably attached to a mount on a front side of the housing of the image capturing apparatus.

7. An image capturing apparatus comprising:
a built-in electronic flash device that emits flash light forward of the image capturing apparatus, the built-in electronic flash device being disposed in a position closer to a front side of a housing of the image capturing apparatus above an optical axis of a taking lens which positions on a front side of the housing of the image capturing apparatus for imaging incident light from a front of the image capturing apparatus;
a viewfinder that displays an image according to an image formed by the taking lens so as to be viewable from behind the housing, the viewfinder being disposed in a position closer to the rear side of the housing above the optical axis of the taking lens; and
a capacitor that accumulates electric charges used for flash light emission of the built-in electronic flash device,
wherein the capacitor is disposed in an internal space of the housing formed between the built-in electronic flash device and the viewfinder.

8. An image capturing apparatus according to claim 7, wherein the viewfinder is an electronic viewfinder that displays an image according to electronic image data.

9. An image capturing apparatus according to claim 7, wherein the capacitor is disposed above a lens barrel constituting the taking lens.

10. An image capturing apparatus according to claim 9, wherein the capacitor is so arranged that the capacitor partially enters into the lens barrel from above.

11. An image capturing apparatus according to claim 7, wherein the taking lens is interchangeably attached to a mount on a front side of the housing of the image capturing apparatus.

12. An image capturing apparatus comprising:
a built-in electronic flash device that emits flash light forward of the image capturing apparatus, the built-in electronic flash device being disposed in a position closer to a front side of a housing of the image capturing apparatus;
an electronic viewfinder that displays an image based on an image formed by the taking lens and captured by an image sensor so as to be viewable from behind the housing, the electronic viewfinder being disposed in a position closer to the rear side of the housing; and
a capacitor that accumulates electric charges used for flash light emission of the built-in electronic flash device,
wherein the capacitor is disposed in an internal space of the housing formed between the built-in electronic flash device and the electronic viewfinder.

13. An image capturing apparatus according to claim 12, wherein the built-in electronic flash device is disposed so as to protrude to a front side of the housing.

14. An image capturing apparatus according to claim 12, wherein the electronic viewfinder includes a liquid crystal display and an eyepiece lens arranged from the front side to the rear side, and the capacitor is disposed in front side of the liquid crystal display.
